(19) United States
(12) Patent Application Publication
(10) Pub. No.: US 2002/0132068 A1
(43) Pub. Date: Sep. 19, 2002

(54) Superstability of thin-walled structures

(76) Inventor: Herman George Onanov, New York, NY (US)

Correspondence Address: HERMAN ONANOV, APARTMENT 3, 419 EAST 117 ST, NEW YORK, NY, 10035, US

(21) Appl. No.: 09/809,973

(22) Filed: Mar. 16, 2001

(51) Int. Cl. B32B 1/02

(52) U.S. Cl. 428/34.1

(57) ABSTRACT

Optimizing an “improper” combination, a combination consisting of an even plate or shell and a conceptually irregular set of reinforcing stiffeners, enables to attain said combination's hitherto unknown unique synergetic attribute, the attribute of total disappearance of local buckling phenomena of said combination when compressing thereof up to destruction of structural material(s) thereof, and therefore enables to utilize strength potentialities of the material per se utterly, just us utterly as when stretching thereof, and besides irrespective of plates/shells shape and size, irrespective of structural materials' kind, volume and weight, and irrespective of operational temperatures and type of external load distribution, etc. Accordingly, given equal other conditions, cardinal weight reduction or bearing capacity's raise of thin-walled structure's bearing skin is attainable that can be utilized for any aerospace thin-walled structure, very extensively in naval engineering, and in civil engineering sometimes also; besides a reduction of expenditures, more efficient utilization of energy resources and hence enhancement of the environment of mankind is provided too. I call said synergic attribute “Superstability”.

### CROSS REFERENCES TO RELATED APPLICATIONS

Not applicable.

### STATEMENT REGARDING FEDERALLY SPONSORED RESEARCH OR DEVELOPMENT

Not applicable

### BACKGROUND

1. Field of Invention

First and foremost this invention relates to aerospace and naval engineering, specifically to any thin-walled structure if bearing (load-carrying) capacity thereof is restricted by local buckling: flying vehicles—aircraft, missiles, super-rocket boosters, . . . any floating ships, esp. submarines, etc.

1. Description of Prior Art

It is well known that structural materials' potentially inherent utmost strength capability remains idle if structure's bearing capacity is limited by compressed parts flexibility.

Everyone knows that a flexible rod suddenly loses its rigidity and buckles if compressed rather strongly. Such phenomenon and causing load's magnitude are called “loss of stability” and “critical load” respectively. As a rule the critical load is considerably less than utmost stretching load.

The loss of stability is typical not only for various, rather flexible rods and the like but in some other forms (local buckling phenomena) for thin-walled structures' bearing skin/shells (casing, covering, sheath, plate) too. As used in this description and in the appended claims, the words “skin” and “shell” are ascribed respectively to thin-walled structure as a whole and to the parts thereof which don't affect each other as regards of loss of stability (e.g. plane's wings and fuselage).

At the moment of a shell's loss of stability a system of alternating local dents and bulges suddenly appears resembling a quilt. A loss of stability happens suddenly, in trice and isn't accompanied as a rule by synchronous destruction. This indicates that structural material's potentially inherent utmost strength remains idle. However even a small additional loading usually results in inadmissible deformations and following destruction.

With given shell's overall dimensions and conditions the critical load's magnitude is conditioned not only by structural material's stiffness and amount but to a very considerable extent by material's arrangement (disposition, distribution) if amount thereof is not too excessive.

A highest relative level of each shell's critical load, i.e. the highest bearing capacity with specified material, weight and size, is the must for any structure's bearing skin if the structure has to meet other things being equal one of the following conditions: minimum weight with requisite bearing capacity or utmost bearing capacity with given weight or else some “golden mean”.

Remark: if material's amount and hence structure's weight is reduced, the highest relative level of critical load naturally decreases too; it's clear, that with given basic dimensions, kind of material, and bearing capacity, the least weight of structure has been attained if corresponding to this weight highest bearing capacity is equal the given (required) one.

Aerospace industry faces a perennial and even acute problem of thin-walled construction of minimal weight but necessary strength. Competition drives companies into heavy investments in research and development of unique materials and sophisticated technologies but advances in weight reduction are all but intangible. Painstaking efforts bring about very modest results. However at the same time at least half elements of any aircraft thin-walled structure—wing, fuselage, tail unit . . . , of any missile's and rocket's body, etc. are compressed; a launch space vehicle's hull is compressed wholly, etc. So, the highest relative level of critical load is the number one problem for aerospace thin-walled structures engineering.

The utmost bearing capacity provided the given weight is probably more important for naval architecture (engineering); e.g. the depth of submarine's and other submersible crafts' dive is in proportion to the water's critical pressure causing loss of stability of crafts bodies.

So, selected the most appropriate structural material, thin-walled structures' designers, especially of large-sized ones, have to reasonably distribute the structural material to optimally stiffen bearing skin up and win the best utilization of material's strength capability.

This is an universal concept. An universal improvement of prior-art methods for thin-walled structures' bearing skin stiffening and consequently the improvement of thin-walled structures, which will embody said concept, is the subject matter of this application.

It is well known that given equal other conditions (shape and basic dimensions, material, weight etc.) reinforced bearing skin considerably excels in bearing capacity uniform one, if structural material is efficiently distributed between the skin proper and its reinforcement. Thin bearing skin, reinforced with a set of longitudinal and transverse elements (stringers, frames, ribs . . .), is widely adopted for a long time. Also different other modes of bearing skin stiffening are well-known. For example presently, to increase the local rigidity and so the critical load, various sandwich type structures are broadly used too, etc.

So, various kinds of manners and means for thin-walled structures' bearing skin stiffening and various combination of them are used and may be thought of. However, in spite of all thinkable diversity of them, there is a self-evident generally accepted taboo: within any part of stiffened skin of thin-walled structure insulated as regards of the loss of stability, i.e. within any shell, stiffening only must be regular; any substantial disturbance of regularity is the blunder.

The optimal material's distribution can be found by means of so-called “optimization”, i.e., essentially, by scrupulous even total theoretical comparison within a preliminarily specified aggregate (multitude) of permissible variants. In fact some optimization procedure in some or other way is carried out in any design process in any event. This is a conventional, in a sense all but routine procedure. However the choice of permissible variants' aggregate is the critical creative thing (crux): the greater said aggregate is, the harder in reality to accomplish said comparison, the more so as it isn't known beforehand whether an aggregate contains noteworthy optimum. But the greater the aggregate is, the more hopes to find something worth while.

Thus, a lucky choice of permissible variants aggregate is imperative. Otherwise the game is not worth the candle. In other words, who thirst for ordinary diamonds—dig up and sift rock like everyone. But dreaming about a stupendous one, endeavor to discover the lucky place regardless! Such a place for bearing skin designers is the subject matter of this application.

In accordance with said taboo only regular patterns of stiffening are optimized. This constraint seems to be irreproachably grounded, sound and indisputable both intuitively and from occupational standpoint too. Even ancient ships had regular frames. As to scientific research on reinforced shells' stability, it has also a long history, even longer than aviation itself; first this problem was apparently scrutinized for shipbuilding. And like in olden days it was believed the Earth is flat, experts unanimously persuaded themselves long ago: the shells' best reinforcement must certainly be only regular; any appreciable disturbance of regularity can't be successful, as a result the shell's bearing capacity can, other things being equal, only decrease but never increase. So, an universal consensus is there: with beforehand chosen stiffening mode, optimum is searched only among regularly stiffened (reinforced) shells; any small breaches of this consensus are unessential.

It is quite reasonable to rate the quality of structural material's distribution by the degree of material's utmost strength capability's utilization. Obviously this utilization could be valued as absolute only if the loss of stability didn't come prematurely, i.e. before structural material's strength properties exhausting up like when stretching. However designers, especially of large-sized thin-walled structures' designers, only can dream about such a fading of distinction between tension and compression. Due to the loss of stability, even in case of scrupulous optimization within the bounds of said consensus, structural material's strength capability of most thin-walled structures usually is utilized extremely slightly, hardly by half and even considerably less. Specialists don't value this as disadvantages but as a due, as an inevitability, perhaps as an acme of perfection, since that must consensus constituted an unshakable conviction—universal credo.

This credo and its consequences constitute the background of my invention “Superstability of thin-walled structures”. The “original” term “Superstability” stands for deliverance from the loss of stability phenomenon and thus—for structural materials' utmost compressing strength capability's utilization. Contrary to common sense and of many years studies, above consensus just as above belief is a blunder. Relevant researches of prior-art people were and are insufficiently rigorous and stupendous godsend remained unclaimed.

### BRIEF SUMMARY OF THE INVENTION

I have discovered the phenomenon of thin-walled structures' bearing shells' superstability, in other words, an universal method for riddance or, strictly speaking, removing the loss of stability event actually up to structural material's strength capability's virtually exhausting and besides irrespective of structure's shape, overall and other basic dimensions, weight, kind and volume of structural materials, operational temperatures, etc.

Any expert can't believe this declaration but anyone must consent: the escape from the loss of stability would mark the Golden Age of thin-walled structures engineering.

In accordance with the present invention a conceptually irregular optimal stiffening of bearing skin is the only distinguishing feature of my superstable thin-walled structures.

I have discovered that superstability is attainable by different manners of stiffening and with any of them, moreover, by different optimal patterns of irregularity.

### OBJECTS AND ADVANTAGES OF THE INVENTION

Superstable thin-walled structures, in contradistinction to prior-art ones, don't lose stability virtually up to structural material's utmost strength exhausting like when ordinary one-axial stretching. This is the basic object, the essence of the present invention.

Accordingly cardinal objectives and advantages of the invention are:

(a) weight reduction or bearing capacity's raise

(b) materials choice like for stretching

(c) adaptability for available structures modernization

(d) expenditures reduction

Objects and advantages of my superstable thin-walled structures will became more apparent from the consideration of the ensuing description and drawings.

### DESCRIPTION OF THE DRAWING FIGURES

Drawings show the outline of longitudinally reinforced plates, prototypes of stringer panel, tested not only theoretically but by means of real physical experiments too.

FIGS. 1P and 1S, respectively, illustrate a prior-art panel and its superstable double-simplest of different possible variants of my superstable structures' main embodiment.

### DESCRIPTION OF THE MAIN EMBODIMENT OF THE INVENTION

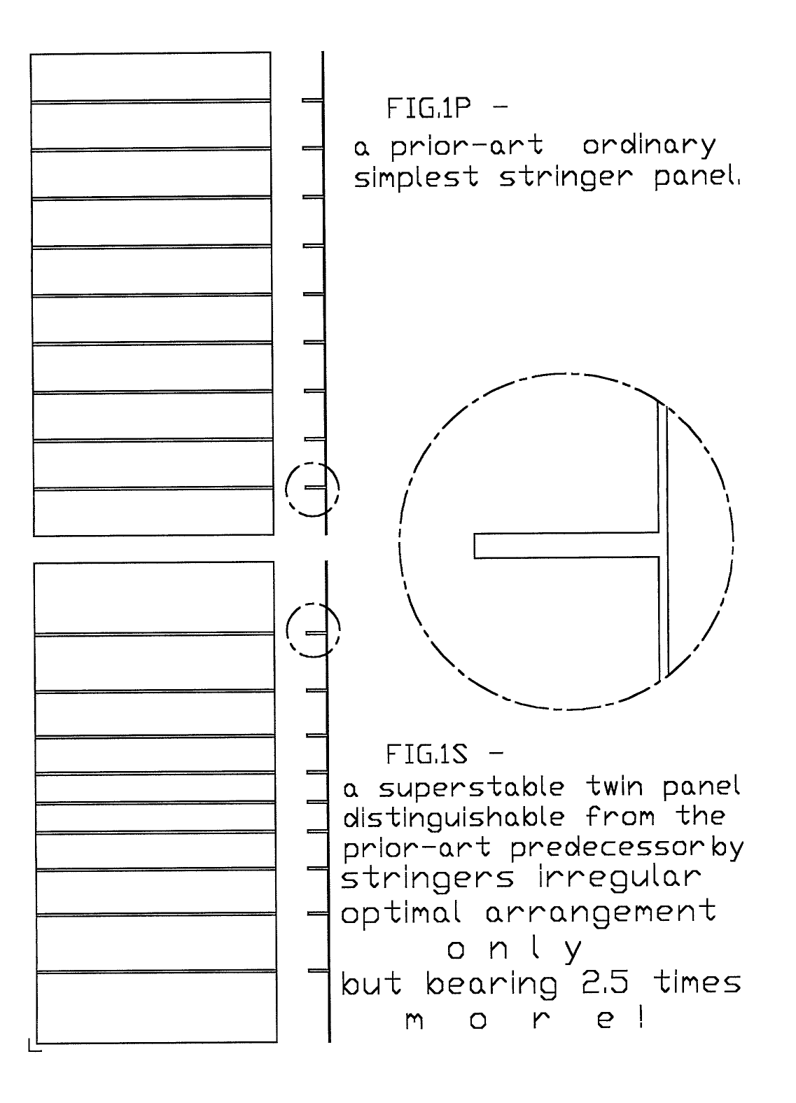

The stiffened thin plates (panels) of the same constant thickness each, shown in FIGS. 1P and 1S, are of the same homogenous material, of the same overall dimensions, of the same weight and both are reinforced in the direction of uniform compressing by the use of the same number of the same identical parallel stringers of simplest (rectangular) uniform cross section.

The prior-art panel, shown in FIG. 1P, is fitted up (reinforced) with a set of identical equidistant stringers, i.e. with a regular stringer set. If material's amount isn't too much excessive for given overall dimensions or if overall dimensions are big enough for given materials' amount, such a panels certainly lose the stability when compressed rather strongly and thus material's utmost strength capability remains idle. This capability can be utilized better by means of optimization within given plate's size, kind of material and its amount. The best combination of panel's variable parameters', i.e. an optimal correlation between the plate's thickness, stringers' number and dimensions of their cross-section, increases panel's bearing capacity to some extent. Nevertheless the material's strength capability of relatively light and especially large-sized regularly reinforced panels is utilized hardly by half or even considerably less.

The panel, shown in FIG. 1S, differs from the regularly reinforced optimal panel, shown in FIG. 1P, with stringers special optimal irregular disposition only.

So, only intervals between stringers were optimized—oversimplified optimization.

Accordingly to the above prior-art taboo, such an arrangement is an absurd, blunder.

However this oversimplified optimal “blunder” provides panels' bearing capacity's jump up 2.5 times and more!

This declaration sounds preposterous. However it is verifiable. Since my comparative experiments are easily reproduced, any expert can be given an opportunity to examine my panels with his own hands and adjudge what is actually a blunder and what is the breakthrough.

Rigorous theoretical and experimental research substantiated: even above practice of irregular stiffening (oversimplified optimization) quite often provides almost ultimate superstability and corresponding inconceivable advantages.

I restate: in comparison with the regularly reinforced optimal panel, shown in FIG. 1P, the bearing capacity of the irregularly reinforced optimal panel, shown in FIG. 1S, jumps up 2.5 times and more if comparing simply-supported panels of the same size, material, and weight, of the same constant thickness of plate, of the same stringers' number, and of the same stringers' cross-section's shape and dimensions, are large enough for given panel's weight, or light enough for given panel's size.

Everything aforesaid about stringer panels, the key elements of most of reinforced thin-walled structures, in full measure pertains to any thin-walled structure's bearing shells, reinforced both only lengthwise and by means of crisscrossed sets of longitudinal and transverse stiffeners, too.

Thus, any thin-walled structure's bearing skin, of any shape and any size, of any material(s) and any weight can be designed superstable!

Superstability always can be won by means of structural materials' optimal distribution between thin bearing skin and conceptually irregular optimal sets of ordinary longitudinal and transverse supportive elements (stiffeners)—stringers, frames, ribs. Modes for fastening thereof to the skin are conventional, the stiffer the better.

Such simplest manner of thin-walled structures superstable stiffening with different optimal patterns of irregularity constitutes the present invention's main embodiment.

### DETAILED DESCRIPTION OF THE INVENTION'S ADVANTAGES

(a) Weight reduction or bearing capacity's raise. Minimal weight but required strength is the problem number one of aerospace thin-walled structures' engineering. Superstability is a way to attain other things being equal an incredible construction weight reduction, even revolutionary for extra large-sized structures. Among many good examples the famous American space launch vehicle Saturn V is apparently one of the best.

Maximal strength with given weight is a topical problem for naval architecture. A good example is a submarine. The depth of submarine's dive is in proportion to the magnitude of critical water's pressure causing submarines' hull's loss of stability. So superstability other things being equal provides an considerable augmenting submarine's and other submersible craft's dive's depth. To all appearance this point doesn't need any additional explanation.

(b) Material's choice like for stretching. Structural materials of higher than usually specific strength (ultimate strength-to-specific gravity ratio) both when stretching and compressing are always more advantageous for superstable structures. However, if structure's bearing capacity is restricted by the loss of stability—regular stiffening, most advantageous material usually is some other one providing the highest but as a rule moderate enough critical load. Therefore, though the transition with the same material from prior-art optimal structure to the superstable one affords given equal other conditions exceptional benefits, the subsequent material's substitute for one of the higher specific strength provides additional benefits. If the level of working temperature of structure's bearing skin is high enough, those extra advantages can be of exceptional significance.

(c) Adaptability for available structures modernization. The infinite field for utilization of superstability is self-evident. None the less it's proper to refer to the example of submarine again. To all appearance it is recommendable to use the superstability not only for new design but for built submarines modernization too, so far as a transition from a regularly reinforced submarines hull to the superstable one doesn't need any change of hull's overall and other basic dimensions, weight, kind and volume of structural materials etc. As a result of a such modernization the greatest dive's depth will increase given equal other conditions so much times as if the submarine were loaded instead of external water pressure with internal pressure of the same value, i.e. would be stretched but not compressed.

(d) Expenditures reduction. The question—how much will the superstability come to, what are the problems accompanying the advantages of superstability—inevitably arises. An answer: the only problem is a sizable even vast volume of necessary computations. In other respects superstable structures are blameless. Unique structural materials and technologies aren't imperative. Ordinary material can be used. Structural materials of higher specific strength are good. Superstability can be attained by means of good old (and simplest) stiffening manner (main embodiment).

Reinforcement's optimal irregularity doesn't put any obstacles. Any technological characteristics of superstable structures are blameless. Hence utilization of the phenomenon of superstability not only isn't in need of additional investments but quite the contrary affords to calculate upon some overall reduction of corresponding expenditures.

### DETAILED DESCRIPTION OF THE INVENTION

Above discovery has been established theoretically and proven experimentally.

The stability of rectangular reinforced plates and shells when compressing was researched in strict non-local aspect—“Discrete-Continuous Model” in order to elaborate the generally accepted ideas based upon the conception of local (separate) study of an compound object's elements, on the one hand, and upon the reinforcement's continuous distribution conception (“spreading model”) on the other hand. Different material's distribution was compared other things being equal to optimal results with regular reinforcement. Almost all results fully corresponded to generally accepted ideas and above taboo both for regular and irregular reinforcement. However with some combinations of parameters of irregularly reinforced plates and shells the magnitude of critical load not only didn't drop but regardless of taboo jumped up several times to the optimum with regular reinforcement. The rigorous theoretical and experimental study show that this phenomenon isn't a blunder but a hitherto unknown reality, the manifestation of synergetic attributes of reinforced plates' and shells' elements' ensemble, i.e. of the combination of elements.

Any reinforced plate or shell is a deformed system of large number interacting elements. This interaction is highly intricate. Each element concurrently affects all the others and back when the whole system tends to buckle up (lose stability). With regular reinforcement this interaction usually is rather significant. If the same reinforcement is arranged irregularly, this interaction changes and can get both less and more significant. Hence the deformed system gets less or more stable. In the majority cases the critical load decreases. However with some unique fortuitous combinations of deformed system's parameters' values the elements reciprocally oppose the buckling of each other and as a result the critical load increases. In principle this opposition can be balanced utterly if combination of system's parameters is optimal—unique, singular combinations, and so the critical load increases up to the virtually utmost value and the loss of stability phenomena and material's strength capability's exhausting befall simultaneously!

Thus irregularly reinforced plates and shells, which do not buckle up when compressing virtually up to material's utmost strength exhausting (like when stretching), were discovered.

I called corresponding phenomenon “Superstability”.

It was established that superstability generally speaking is attainable for any plate or shell of any thin-walled structure of any shape and any basic dimensions and besides with any structure's weight, any structural materials, and any operation temperature.

Finally: superstability, in general, is attainable by means of various stiffening modes and with any of them, moreover, by different patterns of irregularity; the main superstable stiffening manner is an conceptually irregular optimal set of quite ordinary supportive reinforcing stiffeners—stringers, ribs, rings, frames,

The process of attaining thin-walled structure's superstability comprises choosing a manner and means for structure's skin irregular stiffening and optimizing, given equal other conditions required, a combination consisting of bearing skin proper and an irregular set of stiffeners.

Complex structures are circumscribed by aggregate of great number variable parameters. In this connection it is imperative to institute a correct hierarchy of optimizing parameters adequately their significance in the course of optimization process.

Critical factors of superstability are: material's distribution between bearing skin proper and a set of stiffeners, stiffeners' disposition and number. Sooner or later combination of critical factors should be optimized jointly (separately for each shell); in an initial stage of process above oversimplified optimization—the thickness of shell is optimized when stiffeners' set is regular,—is usually expedient.

For main embodiment of invention an aggregate of optimization parameters consist of shell's thickness and parameters of a set of simple, uniform cross-section stringers disposed irregularly in the direction of compressing; or, if compressing is two-axial, said aggregate consist of shell's thickness and parameters of two different irregular sets of ordinary reinforcing stiffeners, of uniform cross-section within each set, disposed longitudinally (stringers) and transversely (frames or ribs).

The possible factors of secondary significance are some distinctions between stiffeners of the same sets, more intricate and even variable lengthwise cross-sections of stiffeners, and so on.

Above hierarchy assists a skilled enough person to trace a shortest route to superstability and get thereof despite a vast volume of requisite computations. Nevertheless, if structure is complicated enough, accomplishing an optimization procedure in a right time requires high-speed computations and therefore most rapid present-day computers are desirable.

Remark: in contrast to stretching, a magnitude of structural material's ultimate compression strength (the yield strength measured when experimental pressing of short thick bars) is slightly vague; so the criterion for ceasing an optimizing process isn't an “absolute highest” relative level of critical load but some “softened” level.

And at last: with the same initial conditions an optimization process can bring to different patterns of superstable irregularity. As regards to bearing capacity and weight a such different optimal structures are approximately equal.

### CONCLUSION, RAMIFICATIONS, AND SCOPE

Thus a reader will see that supportable thin-walled structures of the invention provide the escape from phenomena of structures' bearing skin loss of stability whereby an exceptional weight reduction or bearing capacity's raise is attainable given equal other conditions both for designing future structures and modernizing available ones', that can be used for any aerospace thin-walled structure, very extensively in naval engineering, in civil engineering sometimes also; moreover a reduction of expenditures is provided. And in addition, secondary self-evident material advantages are provided: more efficient utilization and conservation of energy resources and, consequently, enhancement of the environment of mankind by maintenance of the air chemical composition.

Specificities of my above description should not be construed as limitations but rather as an exemplification of preferred embodiment thereof

Many other variations are possible. For example, instead of ordinary single-layer shells, some sandwich type shells can be used completely or partially coupled with conceptually irregular optimal set of ordinary or some other stiffeners; besides homogeneous structural materials, composites can be used also and so on . . .

Also shells of variable thickness, reinforcing bars of variable lengthwise cross-section, and certainly some other means for bearing shells stiffening can be used.

Generally speaking any manner and means, which are used or may be thought of for thin-walled structures regular stiffening, are, giving up of above taboo, eventual objects for superstability's searching by means of optimization of complex combinations consisting of shell (thickness) and conceptually irregular set of stiffeners.

Accordingly the scope of this invention should be determined by the appended claims and their legal equivalents, rather than by embodiments illustrated and examples given.

What I claim as my invention is:

1. In a method of heterogeneous stiffening bearing shells against local buckling phenomena, of the type wherein maximum stability of the bearing shell and so the best utilizing a material thereof is attained by an proper combination consisting of the shell per se and a substantially regular set of stiffeners, the improvement comprising:
optimizing an “improper” combination consisting of the shell per se and a conceptually irregular set of the stiffeners up to attaining said “improper” combination's hitherto unknown unique synergetic attribute, which I call superstability, what signifies the total disappearance of the local buckling phenomena when compressing of said “improper” combination, the disappearance up to destruction of the material thereof, and therefore enables to utilize strength potentialities of the material per se utterly, just us exhaustive as when stretching thereof, irrespective of shape and size of the shell, irrespective of kind and amount of the material, and irrespective of operational temperature and type of external load distribution.

2. The method of claim 1, wherein the stiffeners are reinforcement bars.

3. The method of claim 2, wherein the reinforcement bars are of rectangular cross-section.

4. The method of claim 3, wherein the conceptually irregular set of the stiffeners consist of two different cross groups of the reinforcement bars uniform and unidirectional within each group.

5. The method of claim 3, wherein the conceptually irregular set of the stiffeners consist of one group of the uniform reinforcement bars disposed in the direction of one-axial compression of said “improper” combination.

6. A superstable bearing skin of thin-walled structures, the skin designed accordingly the method of claim 1.

7. The superstable bearing skin of aerospace thin-walled structures, the skin designed accordingly the method of claim 5.

8. Superlight aircraft thin-walled structures comprising the superstable bearing skin of claim 7.

9. Large-capacity superlight airplane thin-walled structures comprising the superstable bearing skin of claim 7.

10. Superlight hulls of ballistic missiles, rockets, launch vehicles, super-rocket boosters, etc. designed accordingly the method of claim 5.

11. Hulls of surface ships comprising the superstable bearing skin of claim 7.

12. Submersible craft's bodies designed accordingly the method of claim 1.

13. A hull of a submarine designed accordingly the method of claim 4.
